(19) United States
(12) Patent Application Publication
(10) Pub. No.: US 2008/0059890 A1
(43) Pub. Date: Mar. 6, 2008

(54) CONFLICT CHECKING AND NOTIFICATION IN AN ELECTRONIC DEVICE

(76) Inventors: Ronald Scotte Zinn, Waterloo (CA); Sherryl Lee Lorraine Scott, Toronto (CA)

Correspondence Address: PERRY + CURRIER (FOR RIM), 1300 YONGE STREET, SUITE 500, TORONTO, ON, M4T-1X3, US

(21) Appl. No.: 11/469,247

(22) Filed: Aug. 31, 2006

(51) Int. Cl. G06F 3/00

(52) U.S. Cl. 715/751

(57) ABSTRACT

A method of operating a portable electronic device is disclosed. The method includes receiving and storing calendared events at the portable electronic device, determining whether ones of the calendared events conflict, ordering the calendar events by time in a list based on respective start date/times, and whether plural calendared events have a same start date/time, ordering the plural calendared events based on respective end date/times, and providing the time-ordered list to the user in a graphical user interface including a notification of conflict if it is determined that the ones of the calendared events conflict.

### FIELD OF TECHNOLOGY

The present disclosure relates to calendar applications and to management and notification of conflicting calendared events at portable electronic devices.

### BACKGROUND

Portable electronic devices including, for example, smart telephones and wireless PDAs are becoming increasingly common and typically integrate functions of personal information management such as calendaring and data communications such as email, World Wide Web browsing and telecommunications in a single device. Such devices run on a wide variety of networks from data-only networks such as Mobitex and DataTAC to complex voice and data networks such as GSM/GPRS, CDMA, EDGE, UMTS and CDMA2000 networks.

Calendar applications permit the user of the portable electronic device to schedule and review calendared events such as appointments and meetings on a visual display such as a liquid crystal display (LCD) screen. Calendared events can typically be viewed in any of a variety of layouts including, for example, a day view, a week view, a month view or an agenda view. An agenda view is typically a list of calendared events with date information, time information, and other identifying information such as subject information in the form of a table, to allow the user to quickly identify the calendared event in the list.

Calendared events are typically entered in a calendar graphical user interface of the portable electronic device, or are transferred or synchronized to the portable electronic device from one or more user accounts such as, for example, an Internet service or an enterprise service. It is not uncommon for conflicts to arise when two or more calendared events overlap. When a calendared event is entered using the graphical user interface of the portable electronic device, the user can be notified of such conflicts upon entry. In some cases, the user may choose to ignore such a conflict, however. For example, the user may choose to ignore a conflict that occurs in the distant future as a result of a recurring event, such as a regular meeting, that conflicts with another calendared event in the future. Frequently users ignore such a conflict in favor of resolving the conflict closer to the date of the conflict. In the event that a calendared event is transferred or synchronized to the portable electronic device, the user may not even be aware that the calendared event conflicts with a calendared event already at the portable electronic device.

Unfortunately, users frequently forget or are not aware of such conflicts, and therefore these conflicts are not resolved.

### BRIEF DESCRIPTION OF THE DRAWINGS

The embodiments described herein will be better understood with reference to the following Figures, in which:

FIG. 1 is a front view of an exemplary portable electronic device;

FIG. 2 is a block diagram of certain components, including internal components within the portable electronic device of FIG. 1;

FIG. 3 is an exemplary home menu screen displayed on a display of the portable electronic device of FIG. 1;

FIG. 4 is a flowchart showing the steps in a method for controlling an electronic device, according to an embodiment;

FIGS. 5 to 8 are exemplary screens showing a list of calendared events on the portable electronic device; and

FIG. 9 is a front view of another exemplary portable electronic device.

### DETAILED DESCRIPTION OF THE EMBODIMENTS

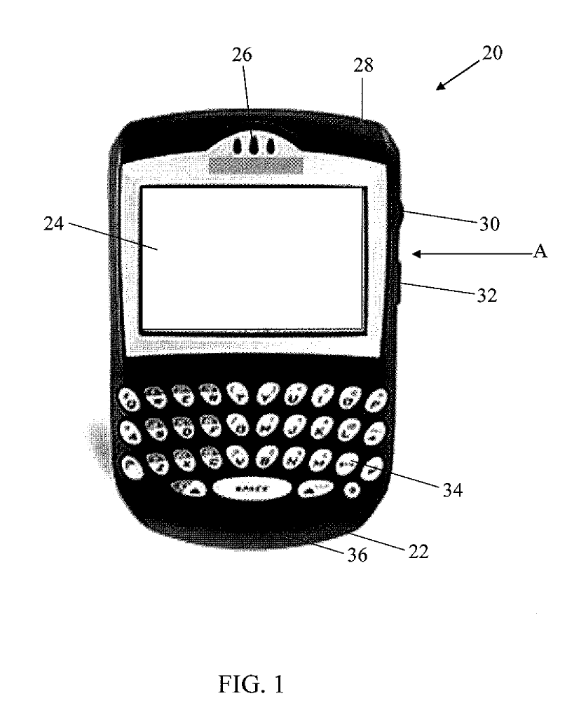

Referring to FIG. 1, an exemplary portable electronic device in accordance with an embodiment is indicated generally by the numeral 20. In the present embodiment, the portable electronic device 20 is based on the computing environment and functionality of a hand-held wireless communication device. It will be understood, however, that the electronic device is not limited to a hand-held wireless communication device. Other electronic devices are possible, such as cellular telephones, smart telephones, and laptop computers. Referring again to the present example, the portable electronic device 20 includes a housing 22 that frames an LCD display 24, a speaker 26, an LED indicator 28, a trackwheel 30, an exit key 32, a key pad 34, and a microphone 36. The trackwheel 30 and the exit key 32 can be inwardly depressed along the path of arrow “A” as a means to provide additional user-input. The housing 22 is made from a suitable material as will occur to those skilled in the art, and can be stored, for example, in a holster (not shown) that includes an attachment for attaching to a user's belt.

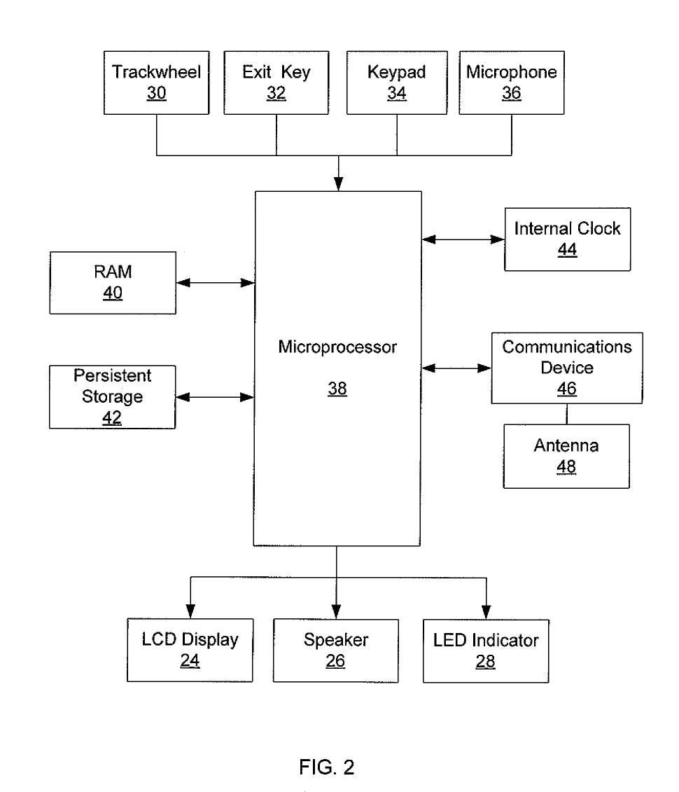

Referring now to FIG. 2, a block diagram of certain components, including internal components within the portable electronic device 20, is shown. The portable electronic device 20 is based on a microcomputer that includes a microprocessor 38 (also referred to herein as a processor) connected to a random access memory unit (RAM) 40 and a persistent storage device 42 that is responsible for various non-volatile storage functions of the portable electronic device 20. Operating system software executable by the microprocessor 38 is stored in the persistent storage device 42, which in the present embodiment is flash memory. It will be appreciated, however, that the operating system software can be stored in other types of memory such as read only memory (ROM). The microprocessor 38 receives input from various input devices including the trackwheel 30, the exit key 32, and the keypad 34, and outputs to various output devices including the LCD display 24, the speaker 26 and the LED indicator 28. The microprocessor 38 is also connected to an internal clock 44.

In the present embodiment, the portable electronic device 20 is a two-way RF communication device having voice and data communication capabilities. The portable electronic device 20 also includes internet communication capabilities. Two-way RF communication is facilitated by a communications device 46 that is used to connect to and operate with a data-only network such as Mobitex or DataTAC, or a complex voice and data network such as a GSM/GPRS, CODMA, EDGE, UMTS or CDMA2000 network, via the antenna 48.

Although not shown, a battery provides power to all active elements of the portable electronic device 20.

The persistent storage device 42 also stores a plurality of applications executable by the microprocessor 38 that enable the portable electronic device 20 to perform certain operations including the communication operations referred to above. Other applications software provided includes, for example, an email application, a Web browser application, an address book application, a tasks application, a calendar application, a profiles application, and others.

It will be appreciated that the calendar application includes a subroutine responsible for providing a graphical user interface (GUI) for the user to create calendared events and for storage of the calendared events in a database at the persistent storage device 42, when executed by the processor 38. The calendar application also includes a subroutine for displaying calendared events such as appointments, lectures, exams, movies, meetings, performances, dinners, ceremonies, etc. as described below. Each calendared event includes a variety of information including a date/time of the event. The term date/time is used throughout the present description. It will be appreciated that the term date/time refers to time and date.

The portable electronic device can be operated by a user to cause the LCD display 24 to provide visual representations of the calendared events stored in a database or in databases on the persistent storage device 42. The calendared events are displayed in a user-selected one of various calendar views including a day view, a week view, a month view and an agenda view. The agenda view provides a list of calendared events, grouped by date under date headings, with time information, and other identifying information such as subject information in the form of a table, to allow the user to quickly identify calendared events in the list.

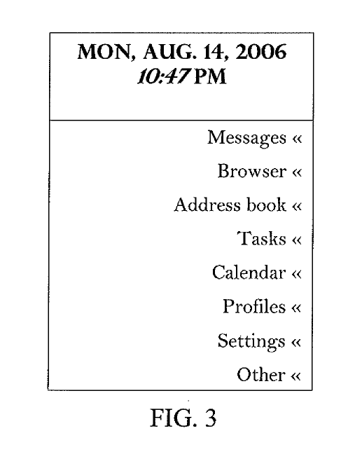

Referring to FIG. 3, there is shown an exemplary home menu screen that is displayed on the LCD display 24 of the portable electronic device 20. The exemplary home menu screen includes a display clock that is updated according to the internal clock 44, and a list of applications including an email messaging application, a Web browser, an Address book, a Tasks application, and a Calendar application. Each of the displayed applications in the list is selectable by, for example, scrolling to the desired application using the trackwheel 30 and pressing inwardly on the trackwheel 30 in the direction of arrow “A”.

Selection of the Calendar application causes execution of the calendar application by the microprocessor 38 and a user-selected one or default one of the calendar views is displayed on the LCD display 24. In the agenda calendar view, a list of calendared events is displayed beginning at the current date according to the internal clock 44. The calendared events scheduled for different days are listed under different day headings, with all calendar events for a specific day listed under the same day heading. The user can scroll ahead in time in the agenda view to show further future calendared events using, for example, the trackwheel 30. Similarly, the user can scroll back in time in the agenda view to show past calendared events using, for example, the trackwheel 30.

Each calendared event in the list includes information such as the start date/time of the calendared event, subject information relating to the calendared event and location information relating to the calendared event. It will be appreciated that the list of calendared events is not limited to this information and other information can be presented to the user. For example, an indication of whether or not a reminder is set for the calendared event and an indication if the calendared event is a recurring event can be displayed. Also, it is possible that some information is not included, such as the location information.

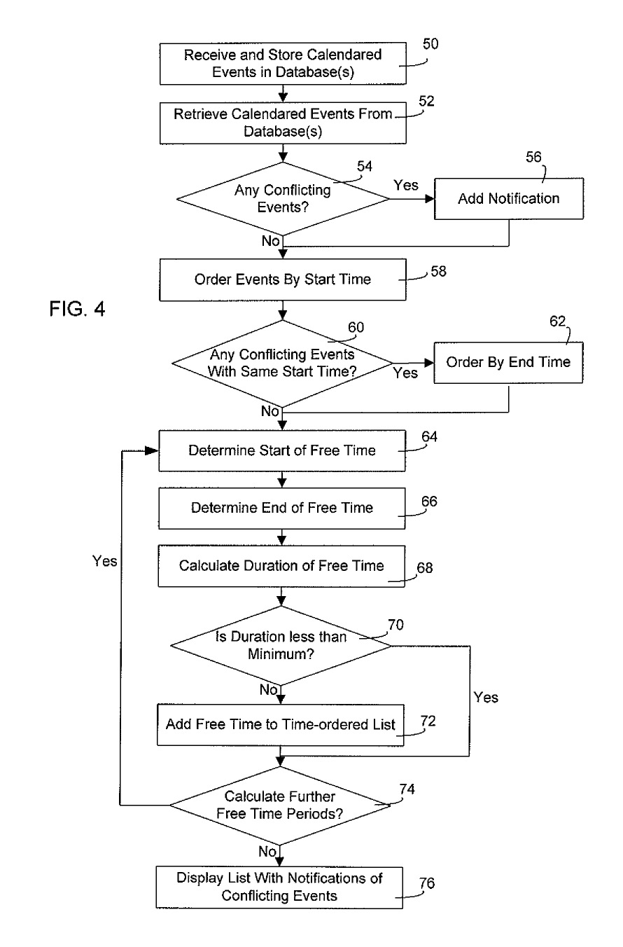

Reference is now made to FIG. 4 to describe an embodiment of the present application. It will be appreciated that each of the steps of FIG. 4 are carried out by the routines and subroutines of the calendar software executed by the microprocessor 38. Coding of software for carrying out the steps in FIG. 4 is well within the scope of a person of ordinary skill in the art. Calendared events are received at the portable electronic device 20 by user selection of the calendar application from the exemplary menu screen shown in FIG. 3, causing the microprocessor 38 to execute the calendar application. This is followed by user selection of a new entry option and user entry of event information in a graphical user interface in a subroutine of the calendar application, as will be understood by those skilled in the art. Alternatively, calendared events are received by synchronization or transfer of calendared events from one or more user accounts at, for example, an Internet service or an enterprise service. Thus, the calendared events can be received from more than one source and are stored in a database at the portable electronic device 20 (step 50). Where calendared events are received from more than one user account, the calendared events can be stored in respective databases at the portable electronic device 20, each database being associated with a respective one of the user accounts. The storage of calendared events in separate databases associated with respective user accounts is disclosed in United States Patent Application filed Jul. 31, 2006, entitled System and Method for Storage and Display of Time Dependent Events and assigned to the assignee of the present application.

Upon user selection of the calendar application from the exemplary menu screen shown in FIG. 3, the microprocessor 38 executes the calendar application as indicated above, resulting in the display of a default view of the calendared events. For the purpose of the present example, the calendar application default view is the agenda view. It will be appreciated, however that the default view can be any view and the view can be changed from any other view to the agenda view by, for example, user selection of an agenda view option in a calendar options menu.

As indicated above, the agenda view provides a list of calendared events. All calendared events received at the portable electronic device 20 that meet specified constraints are retrieved from the database (or databases), in which the calendared events are stored, at the persistent storage device 42 (step 52). The constraints include, for example, a specified number of calendared events that fall within a closest time to the current date/time according to the internal clock 44. For example, up to a total of 15 calendared events that have an earliest start date/time on or after the current date/time are retrieved. Thus, if more than 15 calendared events have a start time on or after the current day, the 15 calendared events with the earliest start times are retrieved. Also, up to 5 calendared events that have a start time prior to the current day are retrieved. In this case, the 5 calendared events with the most recent start times are retrieved. Alternatively, the constraints include a start or end date/time that falls within a specified time span. For example, all calendared events within a certain time span related to the current day are retrieved. For example, the time span could consist of the current day, the day before the current, and the two days after the current day.

After retrieving the calendared events, a determination is made as to whether or not any of the calendared events conflict (step 54). Specifically, the start date/time and end date/time of each calendared event is compared to the start date/times and end date/times of each of the other calendared events to determine whether any of the events have overlapping time periods. Thus, if the start date/time of any calendared event falls on the start date/time of any other calendared event, or within the time period between the start date/time and end date/time of any other calendared event, the events have overlapping time periods and therefore conflict. From the alternative perspective, if an end date/time of any calendared event falls within the time period between the start date/time and end date/time of another calendared event or on the end date/time of another calendared event, the events have overlapping time periods and therefore conflict. It will be appreciated that more than one event can conflict with another event. For each conflicting event, a notification is added to those events to thereby notify the user of conflicts and provide the user with the opportunity to resolve any such conflicts (step 56). The notification will be discussed further below with reference to step 76, in which the notification is provided to the user.

After determining if there are any conflicting events and, if so, adding the notification, the calendared events are ordered by start date/time of each calendared event, in a single time-ordered list. Thus, each of the calendared events is placed in order of start date/time of the calendared events (step 58). If it is determined that any of the calendared events have the same start date/time (step 60), then these calendared events that have the same start date/time are listed within the time-ordered list, in order of their end date/times (step 62). Thus, all calendared events are ordered firstly in order of start date/time and, for those events with the same start times, secondly in order of their date/end times. For exemplary purposes, events with the same start date/time are ordered by the earliest end date/time first. In this example, longer calendared events are listed last.

Next, the start of the next free time period is determined beginning at the current date/time according to the internal clock 44 (step 64). To determine the start of the first free time period, a search is conducted for the first one of: the configured beginning time of a calendar day that does not conflict with a calendared event, the end date/time of a non-conflicting calendared event and the latest end date/time of a set of conflicting calendared events. It will be appreciated that the beginning and end times of the calendar day are user-definable by, for example, user selection of any or both of the beginning of the calendar day and the end of the calendar day from a list of options in a calendar submenu, followed by scrolling to and selection of the user-desired time. Thus, if there are no calendared events that start at the configured beginning of the calendar day or that are in progress at the configured beginning of the calendar day for the current date/time according to the internal clock, the start of the next free time period is determined to be the configured beginning time of the calendar day. If, on the other hand, there is a calendared event that starts at the configured beginning time of the calendar day or that is in progress at the configured beginning time of the calendar day, the start date/time of the free time period is determined to be the next earliest one of either an end date/time of a non-conflicting calendared event (a calendared event which does not overlap with any other calendared event) or the latest end date/time of a set of conflicting calendared events (a set of calendared events that overlap in time).

After determining the start date/time of the next free time period, the end date/time of the free time period is determined (step 66). In this case, the first one of a configured end time of a calendar day, the start date/time of a non-conflicting calendared event, and the earliest start date/time of a set of conflicting calendared events is determined. Thus, if there are no further calendar events for the day, the end date/time of the free time period is determined to be the configured end time of the calendar day. On the other hand, if there are other calendared events for the day, the next earliest one of either a start date/time of a non-conflicting calendared event or the earliest start date/time of a set of conflicting calendared events is determined to be the end date/time of the free time period.

The duration of the free time period is then calculated by subtracting the start date/time of the free time period from the end date/time of the free time period (step 68). The duration calculated in step 68 is then compared to a minimum duration(step 70). For any free time periods that are less in duration than the minimum duration or that have an end date/time that is on or before the current date/time, these free time periods are not added to the time-ordered list at step 72. Instead, the process proceeds to step 74. However, for free time periods that are not less in duration than the minimum duration and that have an end time that is after the current date/time, the free time period is added to the time-ordered list (step 72). Very short free time periods are therefore not added and are not provided for display to the user of the portable electronic device 20. Thus, the time-ordered list that is provided in an agenda view is not cluttered with very short free time periods that, for example, are too short for scheduling further calendared events therewithin. It will be appreciated that the minimum duration can be set to zero so that all free time periods are added to the time-ordered list regardless of their durations. Also, the minimum duration can be user selected in a calendar graphical user interface menu.

At step 74 it is determined if all free time periods that are not less in duration than the minimum duration and fall within a set of constraints, have been added to the time-ordered list. In the example in which calendared events that have a start date/time or end date/time that fall within a time span related to the current day, all calendared events are retrieved that have a start date/time or an end date/time that falls within the time span beginning the day before the current day, and ending two days after the current day. The free time periods are determined that have a start or end date/time that is on or after the current date/time and that fall within the set of constraints defined for the calendared events that are retrieved. In other words, all free time periods that have a start or end date/time that fall after the current date/time and before the end of the two-day period after the current day are determined and are added to the time-ordered list

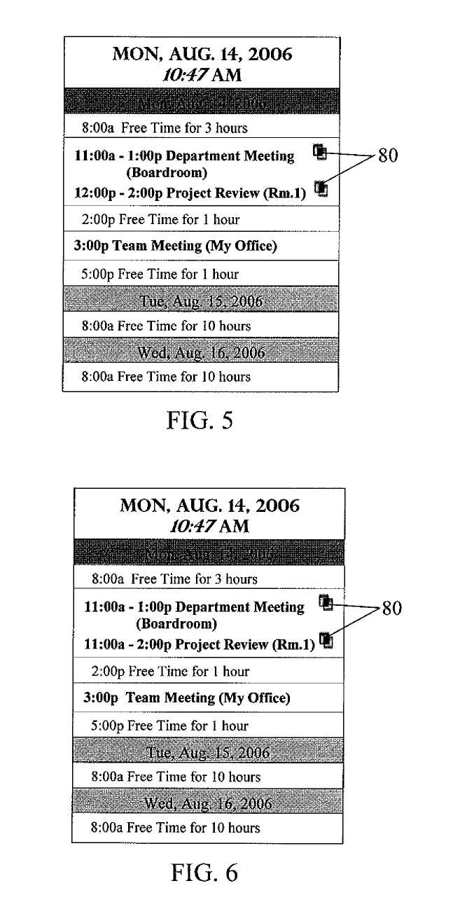

When all free time periods are determined and all suitable-length free time periods are added to the time-ordered list, the time-ordered list is provided to the user in the agenda view at step 76. For any calendared events that are determined to conflict at step 54, the notification added at step 56 is also provided to the user. Reference is made to FIG. 5 which shows an exemplary display screen of the portable electronic device 20. In the present example as shown, the agenda provides all calendared events grouped under date headings according to the date of the calendared event, beginning with the current date according to the internal clock 44. The agenda also provides the subject of each of the calendared events and the location. Two of the calendared events listed under the date heading Mon, Aug. 14, 2006 conflict, however. The end times for these conflicting calendared events are also shown. In the present example, the conflicting calendared events are also shown with a notification of conflict in the form of a graphical conflict representation 80 adjacent each of the conflicting calendared events, to thereby notify the user of the conflicting calendared events and thereby provide the user with the opportunity to resolve any such conflicts.

As shown in FIG. 5, the free time periods are provided in the list. Each of the free time periods is identified and the duration of each free time period is provided. In the present example, the user of the portable electronic device 20 is provided with the free time periods to aid in resolving the conflicting calendared events.

The user can scroll ahead in time using the trackwheel 30 to view future appointments. When the user scrolls to a point where no further calendared events or free time periods are shown in the agenda view, the process is repeated by retrieving a further set of calendared events that meet a new set of constraints. For example, the calendared events that have a start time or an end time that fall within the next two days are retrieved (step 52). The remaining steps in the process are similar to those already described in reference to FIG. 4.

It will be appreciated that in the present embodiment, free time periods are only shown beginning at the current date/time according to the internal clock. Free time periods are not determined or shown for past date/times.

Referring still to FIG. 5, only three calendared events are shown while five free time periods are shown. Three calendared events are received and stored on the portable electronic device at step 50. It will be appreciated that the user of the portable electronic device may have previously been aware of conflicting calendared events. For example, if both events are received at step 50 by user entry in the graphical user interface of the portable electronic device 20, the user may be provided with a conflict indication at the time of entry. In one example, the Department Meeting is a recurring calendared event that recurs every Monday. The Project Review is scheduled for the 14^{th} day of every month. In this case, the user adds the calendared events to the portable electronic device 22 months prior to the occurrence of the conflict and chooses to ignore that there is a conflict, in favour of resolving the conflict closer to the date/time at which the conflict occurs.

In an alternative example, the user enters the Project Review calendared event on the portable electronic device using the graphical user interface. The other calendared events are received when synchronizing a calendar database with a calendar account at an Internet provider. In this example, the user is unaware of the conflict.

For the purpose of the present example, three calendared events are retrieved from the database at step 52 of FIG. 4, the conflict is determined at step 54 and the notification added to the two conflicting events at step 56. The time-ordered list is then created at step 58. Since it is determined that none of the conflicting events have the same start date/time at step 60, the start date/time of the first free time period is then determined at step 64. In this case, the start date/time of the first free time period is the configured start time of the current calendar day (8:00 AM). The end date/time is then determined as the configured start time of the next calendared event (11:00 AM) at step 66. The duration of the free time is calculated at step 68. For exemplary purposes, the minimum duration is set at 15 minutes. Since the free time period exceeds in duration the minimum duration (step 70), the free time period is added to the time-ordered list at step 72. Next, it is determined whether further free time periods are to be calculated. Using the exemplary time constraint of two days after the current time/date, as described above, further free time periods are determined until the start of the next free time period begins on or after the two day period after the current time/date. Since only calendared events for the current date are retrieved at step 52, the free time period for the day after the current day is determined to extend the full length of the calendar day.

At step 76, the user is provided with the list along with a notification of conflict for the conflicting events. With both start date/times and end date/times of each conflicting event shown, the user can determine which calendared events or portions of calendared events to attend. Further, the user is provided with the opportunity to resolve the conflict by, for example, rescheduling one of the conflicting calendared events in the adjacent free time periods shown in FIG. 5. For example, the calendared events for which the user is notified of a conflict overlap by one hour. Either of the calendared events can then be rescheduled using the free time which the user is notified of in the example shown in FIG. 5.

Referring to FIG. 6, a similar exemplary agenda view showing a list of calendared events is shown. In the present example, however, the conflicting events are determined to have the same start date/time at step 60. Thus, these conflicting events are listed in order of their respective end date/times.

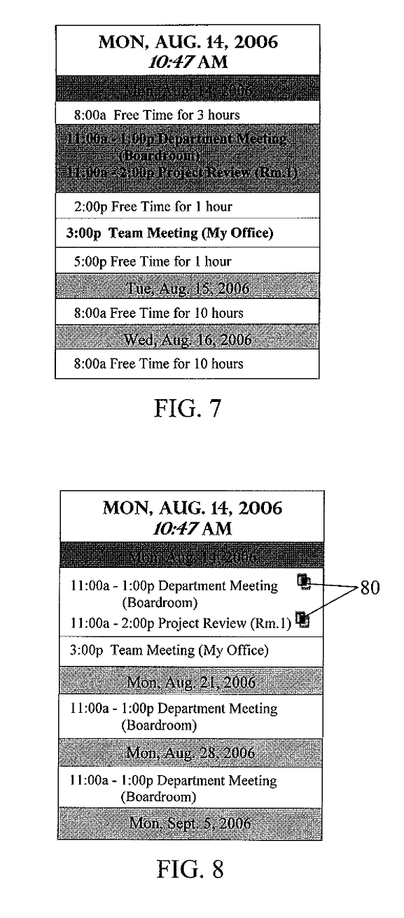

Referring to FIG. 7, another exemplary agenda view is shown. In the present example, the notification of conflict is provided in the form of a highlighted background. For example, the background is highlighted in red to clearly notify the user of the conflict.

Referring now to FIG. 8, still another exemplary agenda view is shown according to another embodiment. In the present example, the free time periods are not shown as in the examples shown in FIGS. 5 to 7. In this embodiment, free time periods are not calculated and therefore after steps 58, 60 and 62 as described in reference to FIG. 4, the process proceeds to step 76.

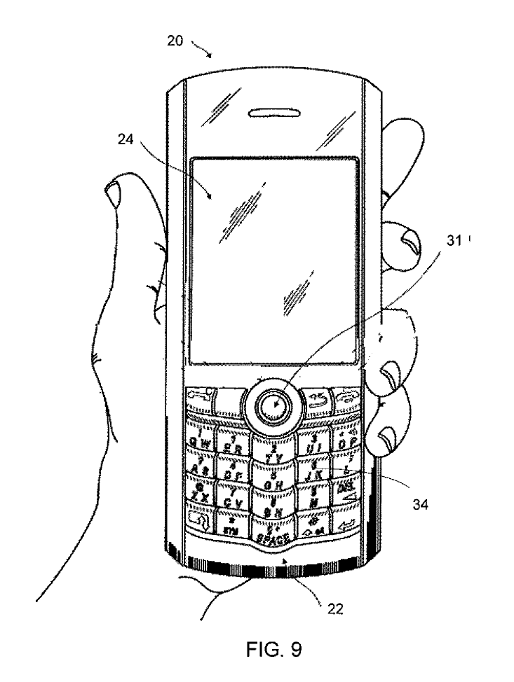

It will be appreciated that the portable electronic device of FIG. 1 is shown for exemplary purposes only. Other portable electronic devices such as that shown in FIG. 9 are possible. Referring to FIG. 9, another exemplary portable electronic device 20 is shown. The portable electronic device 20 includes a housing 22 that frames an LCD display 24. In the present example, however, the portable electronic device 20 includes a trackball 31, rather than a trackwheel. The trackball can be depressed as a means to provide additional user-input. The microprocessor 38 receives input from the trackball 31 which is used for user selection of features from a list or a table on the LCD display 24 of the portable electronic device 22. Selection is carried out by rolling the trackball to roll a cursor (or highlighted region), for example, to the desired selection and pressing inwardly on the trackball. The portable electronic device 20 shown in FIG. 9 includes many other features, including, for example, a key pad 34 and other features similar to those described above with reference to FIG. 1. It will also be appreciated that reference is made to a trackwheel in the above description for exemplary purposes only, and a trackball 31 such as that shown in FIG. 9 can be used.

According to one aspect there is provided a method of operating a portable electronic device. The method includes receiving and storing calendared events at the portable electronic device, determining whether ones of the calendared events conflict, ordering the calendar events by time in a list based on respective start date/times and if plural calendared events have a same start date/time, ordering the plural calendared events based on respective end date/times, and providing the time-ordered list to the user in a graphical user interface including a notification of conflict if it is determined that the ones of the calendared events conflict.

According to another aspect, there is provided a portable electronic device. The portable electronic device includes a display, a processor, and a memory for storage of calendared events and for storage of at least one routine. The routine is executable by the processor for receiving and storing calendared events at the memory, determining whether ones of the calendared events conflict, ordering the calendar events by time in a list based on respective start date/times and if plural calendared events have a same start date/time, ordering the plural calendared events based on respective end date/times, and using the display, providing the time-ordered list to the user in a graphical user interface including a notification of conflict if it is determined that the ones of the calendared events conflict.

According to yet another aspect, there is provided a computer program product for operating a portable electronic device. The computer program product includes a computer-readable medium having computer-readable code embodied therein for execution by a processor at the portable electronic device for receiving and storing calendared events at the memory, determining whether ones of the calendared events conflict, ordering the calendar events by time in a list based on respective start date/times, and if plural calendared events have a same start date/time, ordering the plural calendared events based on respective end date/times, and providing the time-ordered list to the user in a graphical user interface including a notification of conflict if it is determined that the ones of the calendared events conflict.

Advantageously, calendared events are provided to the user in a time-ordered list based on start date/times of the calendared events. For those calendared events that conflict and that have a same start date/time, the calendared events are also ordered by their end date/times. Further, when conflicting calendared events are determined, a notification of the conflict is provided. If only a start date/time of events is provided in said time-ordered list, the end date/times of all conflicting calendared events are also shown. Thus, the user of the device is easily able to determine which meetings can be attended and if, portions of certain meetings can be attended. Further, by providing an indication that calendared events conflict along with an indication of free time periods available, the user is easily able to determine possible alternative times for conflicting calendared events to resolve conflicts.

While embodiments described herein are directed to particular implementations of the portable electronic device 20 and the method for controlling the portable electronic device 20, it will be understood that modifications and variations to these embodiments are within the scope and sphere of the present application. For example, it will be appreciated that the display attributes shown for the free time periods can be user-selected to suit the individual user. Also, calendared events that are retrieved at step 52 can be retrieved from other databases such as a tasks database. As indicated herein, multiple calendar databases that correspond to different calendar accounts synchronized or transferred to the portable electronic device can be maintained. With multiple calendar databases, the calendared events can be retrieved from any or all of the databases.

Many other modifications and variations may occur to those skilled in the art. All such modifications and variations are believed to be within the sphere and scope of the present application.

1. A method of operating a portable electronic device comprising:
receiving and storing calendared events at said portable electronic device;
determining whether ones of said calendared events conflict;
ordering said calendar events by time in a list based on respective start date/times and if plural calendared events have a same start date/time, ordering said plural calendared events based on respective end date/times; and
providing said time-ordered list to said user in a graphical user interface including a notification of conflict if it is determined that said ones of said calendared events conflict.

2. The method according to claim 1, wherein said providing comprises providing said time-ordered list to said user including a conflict indication at each of said ones of said calendared events that conflict.

3. The method according to claim 1, wherein said providing said time-ordered list comprises providing a start date/time of each of said calendared events in said time-ordered list and providing an end date/time of only said ones of said calendared events that conflict.

4. The method according to claim 1, wherein said providing comprises providing said time-ordered list to said user including a visual indication of said ones of said calendared events that conflict.

5. The method according to claim 4, wherein said visual indication comprises a conflict icon adjacent said ones of said calendared events that conflict in said list.

6. The method according to claim 1, comprising:
determining free time periods absent of said calendared events; and
adding said free time periods as in said time-ordered list.

7. The method according to claim 6, wherein said determining comprises determining for each of said free time periods, a start date/time and an end date/time.

8. The method according to claim 7, wherein said determining comprises determining only those free time periods absent of said calendared events that occur on or after a current date/time according to a clock at said electronic device.

9. The method according to claim 7, wherein said determining comprises calculating a duration of each of said free time periods by subtracting said start date/time from said end date/time.

10. The method according to claim 9, comprising comparing said duration of each of said free time periods to a minimum duration prior to said displaying, and wherein said adding comprises adding only those free time periods that are equal to or greater in duration than said minimum duration.

11. The method according to claim 7, wherein said start date/time of each of said free time periods is based on one of a configured start time of a calendar day, an end date/time of a non-conflicting calendared event and a latest end date/time of a set of conflicting calendared events and said end date/time of each of said free time periods is based on one of a configured end time of a calendar day, a start date/time of the next one of said non-conflicting calendared events and an earliest start date/time of a next set of conflicting calendared events.

12. A portable electronic device comprising:
a display;
a processor; and
a memory for storage of calendared events and for storage of at least one routine executable by said processor for:
receiving and storing calendared events at said memory;
determining whether ones of said calendared events conflict;
ordering said calendar events by time in a list based on respective start date/times and if plural calendared events have a same start date/time, ordering said plural calendared events based on respective end date/times; and
using said display, providing said time-ordered list to said user in a graphical user interface including a notification of conflict if it is determined that said ones of said calendared events conflict.

13. The portable electronic device according to claim 12, wherein said notification comprises a conflict indication at each of said ones of said calendared events that conflict.

14. The portable electronic device according to claim 12, wherein said providing said time-ordered list comprises providing a start date/time of each of said calendared events in said time-ordered list and providing an end date/time of only said ones of said calendared events that conflict.

15. The portable electronic device according to claim 12, wherein said notification comprises a visual indication of said ones of said calendared events that conflict.

16. The portable electronic device according to claim 15, wherein said visual indication comprises a conflict icon adjacent said ones of said calendared events that conflict in said list.

17. The portable electronic device according to claim 12, wherein said at least one routine is further for:
determining free time periods absent of said calendared events; and
adding said free time periods in said time-ordered list.

18. The portable electronic device according to claim 17, wherein said determining comprises determining a start date/time and an end date/time for each of said free time periods.

19. The portable electronic device according to claim 17, wherein only those free time periods absent of said calendared events that occur on or after a current date according to a clock at said electronic device are added in said time-ordered list.

20. The portable electronic device according to claim 17, wherein said determining comprises calculating a duration of each of said free time periods by subtracting said start date/time from said end date/time.

21. The portable electronic device according to claim 20, wherein said at least one routine is further for comparing said duration of each of said free time periods to a minimum duration prior to adding said free time periods in said time-ordered list, and wherein said adding comprises adding only those free time periods that are equal to or greater in duration than said minimum duration.

22. The portable electronic device according to claim 17, wherein said start date/time of each of said free time periods is based on one of a configured start time of a calendar day, an end date/time of a non-conflicting calendared event and a latest end date/time of a set of conflicting calendared events and said end date/time of each of said free time periods is based on one of a configured end time of a calendar day, a start date/time of the next one of said non-conflicting calendared events and an earliest start date/time of a next set of conflicting calendared events.

23. A computer program product for operating a portable electronic device, said computer program product comprising a computer-readable medium having computer-readable code embodied therein for execution by a processor at said portable electronic device for:
receiving and storing calendared events at said memory;
determining whether ones of said calendared events conflict;
ordering said calendar events by time in a list based on respective start date/times and if plural calendared events have a same start date/time, ordering said plural calendared events based on respective end date/times; and
providing said time-ordered list to said user in a graphical user interface including a notification of conflict if it is determined that said ones of said calendared events conflict.
